(19) United States
(12) Patent Application Publication
(10) Pub. No.: US 2010/0318308 A1
(43) Pub. Date: Dec. 16, 2010

(54) CALIBRATION IN INDIRECT TIRE PRESSURE MONITORING

(76) Inventors: Fredrik Gustavsson, Linkoping (SE); Urban Forssell, Linkoping (SE)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/531,683

(22) PCT Filed: Mar. 16, 2007
(86) PCT No.: PCT/EP07/02368

§ 371 Date: Mar. 22, 2010

(51) Int. Cl. B60C 23/02; G01L 27/00

(52) U.S. Cl. 702/98

(57) ABSTRACT

A method, system and computer program product for detecting a tire pressure deviation in a tire of a vehicle by determining tire pressure indicating data indicative of a tire pressure condition of the tire and determining tire pressure deviation data indicative of a tire pressure deviation in the tire.

### FIELD OF THE INVENTION

The present invention is directed to calibration in a method and system as well by a computer program product for indirect tire pressure monitoring by determining at least one tire pressure calibration date each thereof associated to different vehicle speed identifying data.

### BACKGROUND OF THE INVENTION

Monitoring of tire pressure can be assumed to become a standard functionality in vehicles, at least in cars and trucks, not only due to governmental and legal regulations but also in view of a general demand for enhanced vehicle safety.

Generally, tire pressure monitoring can be accomplished directly and indirectly.

In direct tire pressure monitoring, a current pressure in a vehicle tire is directly measured, e.g. by means of a sensor arranged inside the tire.

Indirect tire pressure monitoring uses information, which—in contrast to directly obtained pressure values—is somehow related to the tire pressure. Commonly, such information may be provided by further control and/or detection devices of vehicles, such as ECUs (electronic control unit), antilock braking systems, dynamic stability systems, anti-spin systems and traction control systems, in form of digital and/or analog data and/or signals. The information may include the rotational speed or angular velocity of the tire or its wheel, respectively, which information is then used as basis to calculate or estimate a value representing tire pressure. Examples for indirect tire pressure monitoring are, e.g., described in EP 1 403 100 A1, DE 103 60 723 A1 and WO 03/086789 A1.

In indirect tire pressure monitoring, a initially preformed calibration phase is necessary. In the calibration phase information, on the basis of which tire pressure may be determined during normal operation, is used to derive calibration values. The calibration values are used as reference values for subsequent steps to determine tire pressure.

In prior art approaches, for calculation of calibration values different speed ranges are defined. For example, EP 1 403 100 Al discloses speed ranges of 0-50 km/h, 51-100 km/h, 101-150 km/h, 151-200 km/h and 201-250 km/h and DE 103 60 723 Al discloses speed ranges of 0-50 km/h, 50-80 km/h, 80-120 km/h, 120-180 km/h and 180-250 km/h.

During calibration, for each of the separate speed ranges a separate calibration value is calculated. Only in the case a calibration value for a speed range is calculated, (reliable) monitoring of tire pressure is provided in that speed range. To this end it is necessary that the vehicle actually has been in a speed range, for which tire pressure monitoring is to be accomplished, such that calibration for that speed range is possible.

Calibration in indirect tire pressure monitoring however, take several minutes. As a result, for a vehicle, e.g. previously driven at speeds allowed in urban or rural environments and now being driven at higher speed, e.g. on a highway, tire pressure information will not be available as long as no calibration for the respective higher speed range has been completed.

That is, at least for several minutes tire pressure monitoring in a previously calibrated speed range is not possible or at least not reliable. To cover such periods, it is know to estimate calibration values for such speed ranges. EP 1 403 100 A1 discloses to extrapolate calibration values for speed ranges for which no calibration has been completed on the basis of calibration values of adjacent speed ranges for which calibration has been completed. DE 103 60 723 A1 discloses to estimate calibration values for speed ranges for which no calibration has been completed on the basis of calibration values of adjacent speed ranges for which calibration has been completed, particularly by averaging calibration values of an adjacent lower speed range and an adjacent higher speed range.

Prior art approaches have several drawbacks. Calibration is carried out for each speed range resulting in rather long calibration periods for tire pressure monitoring. Also, depending on driving situations, calibration is not performed for all possible vehicle speeds.

### OBJECT OF THE INVENTION

The object of present invention is to provide means improving indirect tire pressure monitoring to overcome the drawbacks of prior art calibration in indirect tire pressure monitoring and, particularly, such that calibration is obtained faster, also for vehicle speeds not prevailing during calibration.

### SUMMARY OF THE INVENTION

To solve the above object, the present invention provides a method, a system and a computer program product as defined in the independent claims.

According to a first aspect the present invention provides a method of calibrating indirect tire pressure monitoring for tires of a vehicle, comprising the steps of:
calculating at least one tire pressure calibration data, each thereof associated to different vehicle speed identifying data; and
determining, on the basis of the at least one tire pressure calibration data, a calibration curve defining tire pressure calibration data for an overall vehicle speed range.

According to another aspect, the present invention provides a system of calibrating indirect tire pressure monitoring for tires of a vehicle, comprising:
means being adapted to calculate at least one tire pressure calibration data, each thereof associated to different vehicle speed identifying data; and
means being adapted to determine, on the basis of the at least one tire pressure calibration data, a calibration curve defining tire pressure calibration data for an overall vehicle speed range.

According to a further aspect, the present invention provides a computer program product for calibrating indirect tire pressure monitoring for tires of a vehicle, the computer program product comprising program code for carrying out, when executed on a processing system, the steps of:
calculating at least one tire pressure calibration data, each thereof associated to different vehicle speed identifying data; and
determining, on the basis of the at least one tire pressure calibration data, a calibration curve defining tire pressure calibration data for an overall vehicle speed range.

Further aspects, features and advantages of the present invention will become apparent from the below description, the accompanying drawings and the appended claims.

### SHORT DESCRIPTION OF THE DRAWINGS

Embodiments of the invention will now be described, by way of example and with reference to the accompanying drawings, in which:

FIG. 1 schematically illustrates a system arrangement according to an embodiment of the present invention;

FIG. 2 schematically illustrates a unit for determining tire pressure calibration data and tire pressure indicating data based on wheel radius analysis according to an embodiment of the present invention; and

FIG. 3 schematically illustrates a unit for determining tire pressure calibration data and tire pressure indicating data based on wheel spectrum analysis according to an embodiment of the present invention.

### DESCRIPTION OF PREFERRED EMBODIMENTS

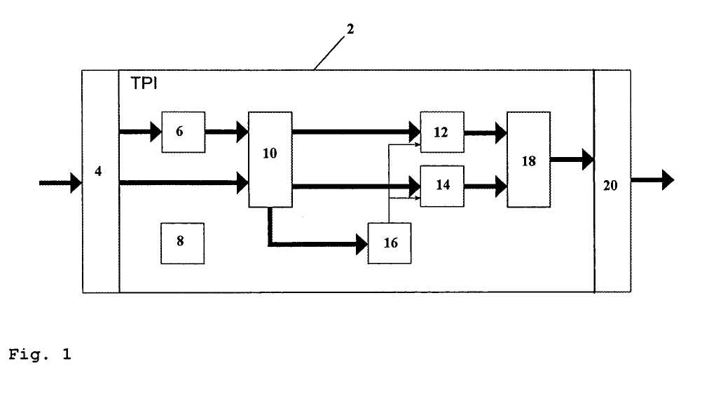

FIG. 1 schematically illustrates a principle system arrangement according to the present invention, particularly in form of a tire pressure deviation (TPD) warning system 2 using indirect tire pressure monitoring.

The present invention is provided for use in any kind of vehicle having at least one wheel equipped with at least one tire.

The term “vehicle” as used herein comprises any type of vehicle, such as cars, bikes, trucks, trailers, and the like, where information on the basis of which indirect tire pressure monitoring is possible.

However, before continuing with descriptions of the drawings, some further observations to further aspects of the present invention are given. More detailed observation to the method related aspects of the present invention also apply to corresponding system related aspects and computer program related aspects of the present invention even if not explicitly noted.

According to the method of the present invention, the vehicle speed identifying data may identify a current speed of the vehicle during the calibrating step.

In further embodiments of the method of the present invention the vehicle speed identifying data may identify an average speed of the vehicle during the calibrating step.

According to the method of the present invention, the overall vehicle speed may essentially correspond with a speed range between a standstill of the vehicle and a maximum speed of the vehicle.

In this regard it is noted that an overall vehicle speed may be at least one of a speed range the vehicle is capable of, a speed range the vehicle is allowed to drive (e.g. due to legal regulations), a speed range the vehicle has been driven in during calibration and a speed range the vehicle has not been driven in during calibration. In any case, it is not necessary that the vehicle has been actually driven in a speed range for a calibration curve is determined. For example, a determined calibration curve may be also valid (or go beyond) a speed range the vehicle has been driven during calibration. In more specific examples, the vehicle may be driven in a speed range ranging from, e.g., 0 km/h to 50 km/h while the calibration curve is applicable to that speed range and speeds above resulting in an overall speed range of, e.g., 0 km/h to 280 km/h.

In the method of the present invention, the step of determining a calibration curve may include a step of selecting a calibration curve from a plurality of predefined calibration curves.

The plurality of predefined calibration curves may include at least of one a polynomial function, a parameterized basis function and a continuous function.

In the method of the present invention, the step of determining a calibration curve may include a step of fitting a calibration curve to the calculated at least one tire pressure calibration data.

In the method of the present invention, at least one of the step of calculating at least one tire pressure calibration data and the step of determining a calibration curve may include a step of using vehicle data indicating at least one of
wheel/tire angular velocity;
wheel/tire rotational speed;
wheel/tire angular velocity energy;
yaw rate;
yaw rate from wheel/tire velocity;
engine torque;
braking in progress;
reverse driving in progress;
active control for the vehicle in progress;
vehicle velocity;
longitudinal acceleration;
lateral acceleration;
wheel slip;
normalized traction force;
gear shift in progress;
data quality indicators concerning quality of data used in the step of calculating at least one tire pressure calibration data;
ambient temperature;
engine temperature;
driving situation and/or condition (e.g. road surface);
tire temperature;
wheel rim temperature; and
vehicle status.

The method of the present invention may further comprise a step of determining tire pressure indicating data, wherein the step of calculating at least one tire pressure calibration data may be performed on the basis of the tire pressure indicating data.

It is further contemplated that step of determining tire pressure indicating data may include a step of obtaining tire radius indicating data.

In the method of the present invention, the step of determining tire pressure indicating data may include a step of roll radius based indirect tire pressure monitoring (e.g. using wheel radius analysis) and/or a step of wheel spectrum analysis.

For the system of the present invention it is contemplated that the vehicle speed identifying data identify a current speed of the vehicle during the calibrating step.

Also in the system of the present invention, the vehicle speed identifying data may identify an average speed of the vehicle during the calibrating step.

In the system of the present invention it is possible that the overall vehicle speed essentially corresponds with a speed range between a standstill of the vehicle and a maximum speed of the vehicle.

In this regard it is noted that an overall vehicle speed may be at least one of a speed range the vehicle is capable of, a speed range the vehicle is allowed to drive (e.g. due to legal regulations), a speed range the vehicle has been driven in during calibration and a speed range the vehicle has not been driven in during calibration.

In the system of the present invention it is possible the means for determining a calibration curve is adapted to select a calibration curve from a plurality of predefined calibration curves.

The plurality of predefined calibration curves may include at least one of a polynomial function, a parameterized basis function and a continuous function.

In the system of the present invention it is possible that the means for determining a calibration curve is adapted to fit a calibration curve to the calculated at least one tire pressure calibration data.

In the system of the present invention, at least one of the means for calculating at least one tire pressure calibration data and the means for determining a calibration curve may be adapted to use, for its respective function, vehicle data indicating at least one of
wheel/tire angular velocity;
wheel/tire rotational speed;
wheel/tire angular velocity energy;
yaw rate;
yaw rate from wheel/tire velocity;
engine torque;
braking in progress;
reverse driving in progress;
active control for the vehicle in progress;
vehicle velocity;
longitudinal acceleration;
lateral acceleration;
wheel slip;
normalized traction force;
gear shift in progress;
data quality indicators concerning quality of data used in the step of calculating at least one tire pressure calibration data;
ambient temperature;
engine temperature;
driving situation and/or condition;
tire temperature;
wheel rim temperature; and
vehicle status.

The system of the present invention may further comprise means being adapted to determine tire pressure indicating data, wherein the means for calculating at least one tire pressure calibration data may be adapted to calculate the at least one tire pressure calibration data on the basis of the tire pressure indicating data.

Here, the means for determining tire pressure indicating data may be adapted to obtain tire radius indicating data and to determine the tire pressure indicating data on the basis of the tire radius indicating data.

In the system of the present invention, the means for determining tire pressure indicating data may be adapted to calculate the tire pressure indicating data based on roll radius based indirect tire pressure monitoring (e.g. using wheel radius analysis) and/or wheel spectrum analysis.

The computer program product of the present invention may further comprise program code for carrying out, when executed on a processing system, the steps of at least one of the above-mentioned possible embodiments of the method of the present invention.

The computer program product of the present invention may be stored on a computer-readable storage medium or in a computer-readable storage device.

Now, referring to the drawings again, FIG. 1 schematically illustrates a principle system arrangement according to the present invention, particularly in form an tire pressure deviation (TPD) warning system 2.

The TPD warning system 2 may for example be a hardware and/or software component, which is integrated in an electronic control unit (e.g. ECU) of a vehicle. The system 2 obtains so-called vehicle data by means of an interface 4, which may be—in the case of an at least partially software based implementation—an application program interface (API). The vehicle data may include vehicle signals from the vehicle CAN bus e.g. describing the vehicle condition. The vehicle data may (further) include measuring data, information, signals and the like directly obtained and/or indirectly derived from vehicle's sensors, such as rotational speed sensors (as existent in the vehicle's ABS), which indicate angular velocities of rotating wheels and tires, respectively.

In particular, the vehicle data may be indicative of wheel/tire angular velocity (e.g. cog stamps of an ABS of the vehicle), wheel/tire rotational speed, ambient temperature, temperature of an engine of the vehicle, engine torque of an engine of the vehicle, torque acting on the at least one tire, engine speed of an engine of the vehicle, yaw rate of the vehicle, velocity of the vehicle, lateral and/or longitudinal acceleration of the vehicle, steering wheel angle of a steering wheel of the vehicle, of a driving condition of the vehicle, particularly a braking condition, gear shift of the vehicle being in progress and an active control device of the vehicle being actively operating.

Any of such data may be used by units for determining tire pressure indicating data, which units are described below.

To provide such vehicle data, an ECU and/or sensors of the vehicle may be used. For example, wheel/tire angular velocity sensor(s), wheel/tire rotational speed sensor(s), temperature sensor(s), yaw rate sensor(s), torque sensor(s), speed sensor(s), accelerator sensor(s), and/or sensors indicating accelerator pedal, clutch pedal and/or braking pedal position(s) my be employed to acquire vehicle data and/or to perform measurements on the basis of which vehicle data may be derived.

The vehicle data may directly provided to units of system 2 and/or may be stored in a memory unit 6 for later use.

A diagnosis control unit 8 performs internal system and input signal checks and sets system status and error codes. If a severe error occurs, this unit can disable the system 2.

Obtained vehicle data may be input to a pre-processing unit 10, which may process (e.g. filters) vehicle data, for example, to remove disturbances and offsets, and may pre-compute vehicle data such that they can be used by other system parts.

According to the described embodiments, interface 4, memory unit 6 and pre-processing unit 10 may be considered as implementation of the step of and/or means for obtaining at least-one vehicle data.

Signals output by pre-processing unit 10 are input to a unit for roll radius based indirect tire pressure monitoring, here exemplarily in form of a wheel radius analysis (WRA) unit 12, and/or a wheel spectrum analysis (WSA) unit 14. To this end,

WRA unit 12 and a WSA unit 14 will be provided vehicle data (unprocessed and/or processed by pre-processing unit 10) at least indicating wheel/tire angular velocity and/or wheel/tire rotational speed.

Further vehicle signals may be related to wheel/tire angular velocity “energy”, yaw rate, yaw rate from wheel/tire velocity, engine torque, braking in progress, reverse driving in progress, active control in progress, vehicle velocity, longitudinal acceleration, lateral acceleration, wheel slip, normalized traction force, gear shift in progress, data quality indicators (dynamic driving, slip variance, etc.), ambient temperature and vehicle status.

In some embodiments, WRA unit 12 and WSA unit 14 may be further provided data indicating, e.g., special driving conditions (e.g. driving with snow chains, on rough roads, on oval track and in a roundabout etc.). Such data may be generated by a dynamic state detector 16 based on vehicle data from interface 4, memory 6 and/or pre-processing unit 10. Thus, data from dynamic state detector 16 are here also referred to as vehicle data as they are derived there from.

Wheel radius analysis as executed in the WRA unit 12 are based on the fact that the wheel speed of a wheel depends on the respective wheel radius: the wheel speed increases with decreasing wheel radius. Changes in the wheel radius contain information about changes in the tire pressure of the corresponding wheel, but may also reflect, e.g., vehicle load changes and surface changes or react on driving forces (acceleration, braking, forces in curves etc.).

In general, WRA unit 12 may detect relative changes in tire pressure for at least two tires.

For example, based on the wheel/tire angular velocity signals and/or wheel/tire rotational speed signals, WSA unit 14 detects changes in the spectral properties of each of the four wheel angular velocity signals. The tire pressure has significant influence on the characteristics of the spectrum of the angular velocity signal; however, further conditions (e.g. driving situation, road surface and temperature) may also have an impact on the angular velocity signal spectrum and may be therefore considered.

In further embodiments, WSA unit 14 may use DFT-based approach(es) and/or method(s) to determine wheel/tire spectrum.

In any case, WSA unit 14 may detect changes in tire pressure for each wheel individually, for example by calculating a parametric model of the wheel/tire velocity spectrum and using the parameters of this model to calculate a spectral shape factor that condenses the different pressure dependent features of the spectrum into one single scalar quantity.

Tire pressure indicating data may provided by WRA unit 12 only or by WSA unit 14 only or by both WRA unit 12 and WSA unit 14.

A combination unit 18 obtains data from WRA unit 12 and/or WSA unit 14 and from interface 4, memory unit 6 and/or pre-processing unit 10.

More specifically, data provided to combination unit 18 include tire pressure indicating data of at least one of WRA unit 12 and WSA unit 14. Such data will be used to determine tire pressure deviation data indicative of tire pressure deviation condition(s) for the vehicle tire. To this end, combination unit 18 may also use data indicating, e.g., special driving conditions (e.g. driving with snow chains, on rough roads, on oval track and in a roundabout etc.) provided by dynamic state detector 16 and/or further vehicle data.

In general, combination unit 18 determines, based on input data, tire pressure deviation condition(s) for each tire separately or for at least two tires together. In embodiments not illustrated, combination unit 18 determines whether tire pressure indicating data indicate a deviation from a preset, desired and/or required tire pressure. To this end, combination unit 18 may additionally take into account vehicle data, e.g., such as indicated above.

If an inappropriate tire pressure deviation condition is detected, combination unit 18 may generate warning data, enable a warning signal and the like to inform about the inappropriate tire pressure deviation condition. Such warning information may be coupled, via an interface 20, to an ECU of the vehicle and/or a warning unit (not shown) of system 2.

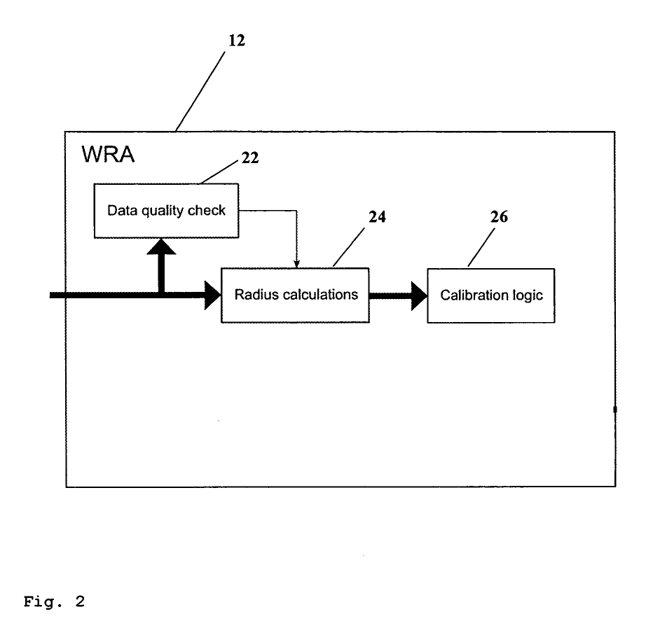

FIG. 2 illustrates an embodiment of WRA unit 12 comprising an optional data quality check unit 22, a unit 24 for calculating wheel/tire radius and a calibration unit 26.

WRA unit 12 receives vehicle data and/or data derived from vehicle data from at least one of interface 4, memory unit 6 and/or pre-processing unit 10. It is noted again that data directly and/or indirectly derived from vehicle data are also referred to as vehicle data here.

Optional data quality check unit 22 may be used to ascertain whether or not vehicle data are suitable for being used by wheel/tire radius calculating unit 24 and/or calibration unit 26. For example, current driving situation(s) and/or vehicle status might affect to be used vehicle data such that no or no reliable tire pressure indicating data can be determined. For such cases it is contemplated to disable calibration at least in the period of time having no or no reliable tire pressure indicating data. Calibration may be resumed when suitable vehicle data and/or (reliable) tire pressure indicating data are available again.

Wheel/tire radius calculating unit 24 determines, based on based on vehicle data, for example the wheel/tire angular velocity signals and/or wheel/tire rotational speed signals, tire pressure indicating data indicative of (absolute and/or relative) current tire pressure(s) of tire(s) to be monitored. This may be accomplished by means of wheel radius analysis as set forth above with WRA unit 12.

Without calibration, tire pressure indicating data determined by wheel/tire radius calculating unit 24 may be (approximately) correct or not. Particularly in embodiments where relative measurements are used to achieve tire pressure indicating data calibration may be prerequisite.

For calibration, wheel/tire radius calculating unit 24 obtains vehicle data on the basis, which tire pressure indicating data would be determined in normal operation. In calibration such vehicle data is computed as for determination of tire pressure indicating data in normal operation. However, the results are not used for tire pressure monitoring but for calibration. Nevertheless, data derived from vehicle data for calibration are also referred to as tire pressure indicating data.

For example, wheel/tire radius calculating unit 24 determines tire pressure indicating data for a vehicle speed of 30 km/h. In cases where it can be assumed that tire pressure indicating data for a specific vehicle speed determined once are substantially reliable that tire pressure indicating data may be used a calibration data. Otherwise, determination of tire pressure indicating data for a vehicle speed is repeated several times, e.g. twice, three times, four times, . . . , thirty-five times, n-times. These tire pressure indicating data are then used to calculate calibration data for the vehicle speed.

In case where tire pressure indicating data is determined several times, it is possible to do so not for a certain vehicle speed but within a certain vehicle speed range, e.g., between 25 km/h and 35 km/h. The respective tire pressure indicating data are then used to calculate calibration data for that vehicle speed range.

For calculation of calibration data, tire pressure indicating data may be, for example, averaged and the resulting average may be used calibration data. In further embodiments, median value(s) of tire pressure indicating data may be used a basis for calculation of calibration data. In still further embodiments, average(s) of tire pressure indicating data may be calculated—with or without forgetting factor(s)—to obtain data that may be used a basis for calculation of calibration data. It is also contemplated to use moving average(s) of tire pressure indicating data to obtain a basis for calculation of calibration data.

Depending on, for example, predetermined system settings, actual driving situations (e.g. driving at lower or higher speeds only), current need of tire pressure monitoring (e.g. tire pressure monitoring is required for higher speed(s) immediately although no driving situation at the higher speed(s) occurred previously), calibration data for two, three, four, . . . , n different vehicle speeds and/or different vehicle speed ranges may be calculated. However, it is not necessary to calculate calibration data for the overall speed range the vehicle is capable of and/or in which tire pressure monitoring is to be provided.

In contrast to known approaches, according to the present invention, it is not necessary to calculate calibration data for each vehicle speed or vehicle speed range for which tire pressure monitoring is desired. Also, the present invention eliminates the need to extrapolate and/or interpolate calibration data for vehicle speed or vehicle speed range based on calibration data for lower and/or higher vehicle speed and/or adjacent vehicle speed range(s) during drive.

According to the present invention, the at least one calibration data is used to determine a calibration curve, which defines for all speeds in an overall speed range how tire pressure indicating data are to be calibrated in order to obtain reliable tire pressure indicating data and, thus, reliable tire pressure monitoring.

In some embodiments, the overall speed range for which a calibration curve is determined corresponds with an overall speed range the vehicle is capable of (e.g. 0 km/h-300 km/h), is a range of speeds allowed to drive (e.g. 0 km/h-100 km/h) and/or is range of vehicle speeds in which tire pressure monitoring is to be provided (e.g. 0 km/h-50 km/h).

Calibration curves may calculated on the basis of previously calculated calibration data, e.g., to obtain a linear or nonlinear (e.g. second, third, . . . , n-th order function). For example, a polynomial function or a parameterized basis function may be used. In such cases the at least one calibration data may be employed as function parameter while vehicle speed may be a variable of the function. Further function parameter(s) may include one ore more vehicle data, e.g. those indicated above.

On the basis of previously calculated calibration data a suitable calibration curve may be selected from a set of predefined calibration curves. The calibration curves set may include, for example, standardized calibration curves, vehicle specific calibration curves (e.g. different vehicle types of the same manufacturer; sedan, station wagon, sports car), tire specific calibration curves, calibration curves specific for different driving styles (reserved/moderate, normal, sportive, aggressive), driver specific calibration curves (e.g. grandparents, parents, children) and driving condition specific calibration curves (e.g. drives mainly on highways, in towns, in the mountains). Further, calibration curves may be based on empirical (statistical) information, e.g., on tire pressure during actual vehicle operation and/or a tire having the same or a comparable behavior as a tire to monitored, physical/mathematical modeling and/or experiments, databases etc.

Also, data indicating other deviations related to tire(s) may be included. For example, tire wear, tire/wheel imbalances, and/or objects and/or masses “adhering” to a tire/wheel (e.g. rim at least partly filled with snow, mud etc.) may be taken into account in determining a calibration curve even more optimize to a current driving situation/condition.

In such cases the at least one calibration data may be not only used to select a (most) appropriate calibration curve but may be also employed to adapt and/or fit a selected calibration curve to the at least one calibration data. Further prior parameter(s) for selecting and/or adapting a calibration curve may include one ore more vehicle data, e.g. those indicated above.

According to the present invention, a calibration curve used in tire pressure monitoring may be continuous. This avoids—as compared with prior art approaches—discontinuities in calibration values for different speeds (e.g. Prior art approaches using several distinct speed ranges for calibration have a calibration value for a speed range and another calibration value for an adjacent speed range; as a result, transition between adjacent speed ranges leads to discontinuous changes in calibration values.)

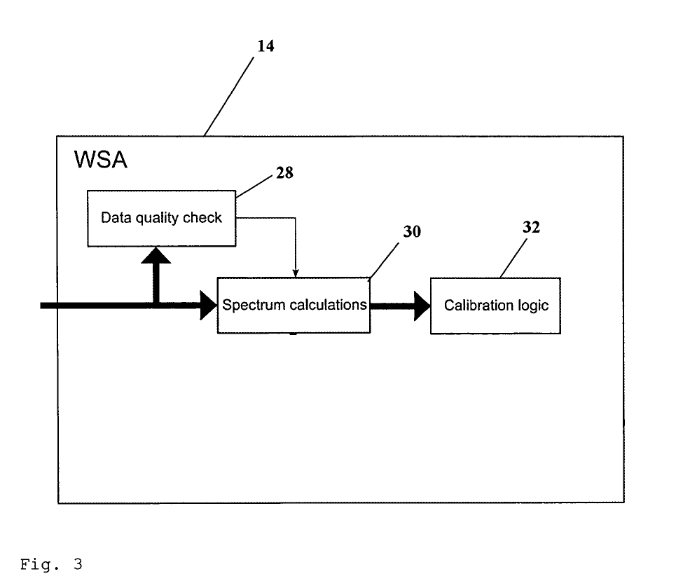

FIG. 3 illustrates an embodiment of WSA unit 14 comprising an optional data quality check unit 28, a unit 30 for calculating wheel/tire radius and a calibration unit 32.

The above observations concerning optional data quality check unit 22 , a unit 24 for calculating wheel/tire radius and a calibration unit 26 of WRA unit 12 also apply to the units of WSA 14 apart from the way tire pressure indicating data is determined. Here, tire pressure indicating data is determined on the basis of wheel spectrum analysis rather than on wheel radius analysis.

It is noted that in embodiments only WRA unit 12, in embodiments only WSA unit 14 and in embodiments both WRA unit 12 and WSA unit 14 may be used for calibration.

As a result, calibration unit 26 taken alone, calibration unit 32 taken alone or calibration unit 26 and calibration unit 32 in combination may be considered as implementation of the step of and/or the means for calculating at least one tire pressure calibration data and determining a calibration curve.

In line therewith, unit 24 for calculating wheel/tire radius taken alone, unit 30 for calculating wheel/tire radius taken alone or unit 24 for calculating wheel/tire radius and unit 30 for calculating wheel/tire radius in combination can be considered as implementation of the step of and/or means for determining tire pressure indicating data.

According to the present invention, calibration may be initiated under control of an ECU of the vehicle or system 20 itself, e.g. at ignition, after change of wheel/tire. Also, calibration may be initiated by the driver.

Further, in some embodiments, it is contemplated to carry out calibration during normal operation in order to ascertain whether a calibration curve currently used in tire pressure monitoring is (still) suitable or should be at least partially corrected or replaced. In such cases, a current calibration curve may be used unmodified as long as no determination has been made that calibration should be updated or refined.

Correction of a current calibration curve may be achieved by modifying the same based on, for example, calculating at least one new tire pressure calibration data and adapting the current calibration curve on the basis of the at least one new tire pressure calibration data.

Replacing a current calibration curve may be achieved by, for example, calculating at least one new tire pressure calibration data and determining a new calibration curve on the basis of the at least one new tire pressure calibration data and, optional, on the basis of previously calculated tire pressure calibration data.

In some embodiments, previous tire pressure calibration data may be dismissed when new tire pressure calibration data is available. In some embodiments, previously tire pressure calibration data may be used in combination with new(er) tire pressure calibration data. Such combinations may include to prioritize new(er) tire pressure calibration data over previous tire pressure calibration data, for example, by weighting factors.

1.-29. (canceled)

30. A method of calibrating indirect tire pressure monitoring for tires of a vehicle, comprising :
calculating at least one tire pressure calibration data, each thereof associated to different vehicle speed identifying data; and
determining, on the basis of the at least one tire pressure calibration data, a calibration curve defining tire pressure calibration data for an overall vehicle speed range.

31. The method of claim 30, wherein the vehicle speed identifying data identify a current speed of the vehicle during the calibrating step, or the vehicle speed identifying data identify an average speed of the vehicle during the calibrating step.

32. The method of claim 30, wherein the overall vehicle speed essentially corresponds with a speed range between a standstill of the vehicle and a maximum speed of the vehicle, wherein the overall vehicle speed is at least one of a speed range the vehicle is preferably capable of, a speed range the vehicle is allowed to drive, a speed range the vehicle has been driven in during calibration and a speed range the vehicle has not been driven in during calibration.

33. The method of claim 30,
wherein determining a calibration curve includes selecting a calibration curve from a plurality of predefined calibration curves, wherein the plurality of predefined calibration curves preferably includes at least one of a polynomial function, a parameterized basis function and a continuous function; and/or
wherein determining a calibration curve includes fitting a calibration curve to the calculated at least one tire pressure calibration data; and/or
wherein at least one of calculating at least one tire pressure calibration data and determining a calibration curve includes using vehicle data indicating at least one of
wheel/tire angular velocity;
wheel/tire rotational speed;
wheel/tire angular velocity energy;
yaw rate;
yaw rate from wheel/tire velocity;
engine torque;
braking in progress;
reverse driving in progress;
active control for the vehicle in progress;
vehicle velocity;
longitudinal acceleration;
lateral acceleration;
wheel slip;
normalized traction force;
gear shift in progress;
data quality indicators concerning quality of data used in calculating at least one tire pressure calibration data;
ambient temperature;
engine temperature;
driving situation and/or condition;
tire temperature;
wheel rim temperature; and
vehicle status; and/or further comprising determining tire pressure indicating data,
wherein calculating at least one tire pressure calibration data is performed on the basis of the tire pressure indicating data, wherein determining tire pressure indicating data preferably includes obtaining tire radius indicating data; and/or
wherein determining tire pressure indicating data preferably includes roll radius based indirect tire pressure monitoring, preferably using wheel radius analysis, wherein determining tire pressure indicating data includes wheel spectrum analysis.

34. A system of calibrating indirect tire pressure monitoring for tires of a vehicle, comprising:
means being adapted to calculate at least one tire pressure calibration data, each thereof associated to different vehicle speed identifying data; and
means being adapted to determine, on the basis of the at least one tire pressure calibration data, a calibration curve defining tire pressure calibration data for an overall vehicle speed range.

35. The system of claim 34, wherein the vehicle speed identifying data identify a current speed of the vehicle during the calibrating step; or wherein the vehicle speed identifying data identify an average speed of the vehicle during the calibrating step.

36. The system of claim 34,
wherein the overall vehicle speed essentially corresponds with a speed range between a standstill of the vehicle and a maximum speed of the vehicle, wherein overall vehicle speed may be at least one of a speed range the vehicle is preferably capable of, a speed range the vehicle is allowed to drive, a speed range the vehicle has been driven in during calibration and a speed range the vehicle has not been driven in during calibration; and/or
the means for determining a calibration curve is adapted to select a calibration curve from a plurality of predefined calibration curves, wherein the plurality of predefined calibration curves preferably includes at least one of a polynomial function, a parameterized basis function and a continuous function;
and/or
the means for determining a calibration curve is adapted to fit a calibration curve to the calculated at least one tire pressure calibration data; and/or
at least one of the means for calculating at least one tire pressure calibration data and the means for determining a calibration curve is adapted to use, for its respective function, vehicle data indicating at least one of
wheel/tire angular velocity;
wheel/tire rotational speed;
wheel/tire angular velocity energy;
yaw rate;
yaw rate from wheel/tire velocity;
engine torque;
braking in progress;
reverse driving in progress;
active control for the vehicle in progress;
vehicle velocity;
longitudinal acceleration;
lateral acceleration;
wheel slip;
normalized traction force;
gear shift in progress;
data quality indicators concerning quality of data used in calculating at least one tire pressure calibration data;
ambient temperature;
engine temperature;
driving situation and/or condition;
tire temperature;
wheel rim temperature; and
vehicle status; and/or
further comprising means being adapted to determine tire pressure indicating data, wherein the means for calculating at least one tire pressure calibration data is adapted to calculate the at least one tire pressure calibration data on the basis of the tire pressure indicating data, wherein the means for determining tire pressure indicating data is preferably adapted to obtain tire radius indicating data and to determine the tire pressure indicating data on the basis of the tire radius indicating data, wherein the means for determining tire pressure indicating data is preferably adapted to calculate the tire pressure indicating data based on roll radius based indirect tire pressure monitoring, preferably using wheel radius analysis wheel radius analysis, wherein the means for determining tire pressure indicating data is preferably adapted to calculate the tire pressure indicating data based on wheel spectrum analysis.

37. A computer program product for calibrating indirect tire pressure monitoring for tires of a vehicle, the computer program product comprising program code for carrying out, when executed on a processing system:
calculating at least one tire pressure calibration data, each thereof associated to different vehicle speed identifying data; and
determining, on the basis of the at least one tire pressure calibration data, a calibration curve defining tire pressure calibration data for an overall vehicle speed range.

38. The computer program product of claim 37, further comprising program code for carrying out, when executed on a processing system, at least one of the alternatives of
wherein the vehicle speed identifying data identify a current speed of the vehicle during the calibrating step, or the vehicle speed identifying data identify an average speed of the vehicle during the calibrating step;
and/or
being stored on a computer-readable storage medium or in a computer-readable storage device.
